(19) United States
(12) Patent Application Publication
(10) Pub. No.: US 2015/0006303 A1
(43) Pub. Date: Jan. 1, 2015

(54) Intelligent Menu Restaurant and Diner Interface

(71) Applicant: RKLIT LLC, Cedar Park, TX (US)

(72) Inventor: Michael Edward Little, Cedar Park, TX (US)

(21) Appl. No.: 14/320,021

(22) Filed: Jun. 30, 2014

Related U.S. Application Data
(60) Provisional application No. 61/841,528, filed on Jul. 1, 2013.

(51) Int. Cl. G06Q 30/02; G06Q 30/06; G06Q 50/12

(52) U.S. Cl. CPC G06Q 30/0282; G06Q 50/12; G06Q 30/0633
USPC 705/15

(57) ABSTRACT

A comprehensive system of hardware and software that will simultaneously engage the restaurant customer (the diner) and conveniently improve their dining experience while allowing them to provide feedback as well as give the restaurant owner a tool to analyze and manage feedback to improve customer service and optimize operations.

### CROSS-REFERENCE TO RELATED APPLICATIONS

This application claims the benefit of U.S. Provisional application 61/841,528 filed Jul. 1, 2013.

### BACKGROUND

Diners in full-service restaurants value food quality and the quality of service above all other factors when dining out. Despite this fact, restaurants primarily invest in technology that focuses on their back-end operations, such as the point-of-sale (POS) system. Current efforts restaurants employ to gain diner feedback include monitoring restaurant review sites like Yelp and UrbanSpoon, survey prompts on table tents or receipts, and manager face-to-face interaction. Negative ratings on restaurant review sites have put owners in a situation where they must endure the negative economic effects of bad online reviews without the ability to address the issue or the information necessary to make the correct changes. Surveys on receipts and table tents produce low response rates. Face-to-face manager interaction, while essential, is non-measurable and costly. Meanwhile, diners who patronize restaurants are becoming increasingly comfortable using mobile technology to give feedback on their experiences. The smartphone adoption rate in the US is currently at 55% and growing rapidly and diners are using their smartphones everywhere they go. Restaurants currently lack an effective way engage and interact with their diners in order to increase diner retention, sales per table, and overall restaurant profitability.

Accordingly a need exists to change this dynamic. Restaurant owners need a system that will dramatically improve their interaction with diners through actively managed interaction while providing much improved service to the diners to improve their dining experience.

### SUMMARY

The need is addressed by a comprehensive system of hardware and software that will simultaneously engage the consumer (the diner) and conveniently improve their dining experience while allowing them to provide feedback by the action taken on the smart device. These actions can be analyzed by the retail business in a real-time manner to improve customer service and optimize operations.

This is done with a cloud base utility system that provides relevant and applicable restaurant information to both restaurant owners and restaurant diners though mobile technologies. It is designed for easy integration of mobile apps that are developed for the restaurant and hospitality industry. This system simplifies a closed loop continuous improvement system by taking diner feedback and providing that data in an easy applicable way for business and diners to use.

Some elements of the complete system are:

Data Collection from restaurant diners via Mobile Technologies—ability to collect millions of data points from diners around the world.

Data Integration and formation to knowledge assets—to present this large amount of data to allow for easy consumption and then action.

Open API Interface software development kit that will allow for other companies to develop plug-in-play applications that can easily plug into the proposed platform and take full advantage of the Data, and Analytics.

Analytics Engine—This system will have built in analytics that give real-time feedback to both restaurant owners and restaurant diners.

This can be done with a system for simultaneously linking restaurant diners and restaurant owners through a website to provide useful information to both comprising: an intelligent menu app for use by diners on a mobile smartphone device; a website for use by restaurant owners on a computer interface within the plurality of restaurants and in communication via the website with the mobile smartphone devices of diners who visit their restaurant; at least one software application on the website for use by the restaurant owners in managing restaurant and digital information on each restaurant; at least one software application on the website for managing orders and payments from the diners and the restaurant owners; at least one software application on the website for managing feedback from diners to the restaurant owners on the dining experience; at least one software application on the website for providing special services for the diners and the restaurant owners; at least one software application on the website for managing direct communications between the diners and the restaurant owner.

This can also be done with a method for simultaneously linking restaurant diners and restaurant owners through a website to provide useful information to both comprising the steps of: providing a first intelligent menu application for use by diners on a mobile smartphone device; providing a website for use by restaurant owners on a computer interface within the plurality of restaurants and in communication via the website with the mobile smartphone devices of diners who enter their restaurant; providing at least one software application on the website for use by the restaurant owners in managing restaurant and menu information on each restaurant; providing at least one software application on the website for managing orders and payments from the diners and the restaurant owners; providing at least one software application on the website for managing feedback from diners to the restaurant owners on the dining experience; providing at least one software application on the website for providing special services for the diners and the restaurant owners; and providing least one software application on the website for managing direct communications between the diners and the restaurant owner.

This real-time access to applicable information will enable restaurant owners to make smarter buying decisions and to understand who their diners are and what they think about their products and services.

### BRIEF DESCRIPTION OF THE DRAWINGS

FIG. 1 is an illustrative overview of the complete intelligent menu system.

FIG. 2 is an illustrative overview of the Applications Layer Manager suites.

FIG. 3 is an illustrative view of many of the databases of the intelligent menu system.

### DETAILED DESCRIPTION

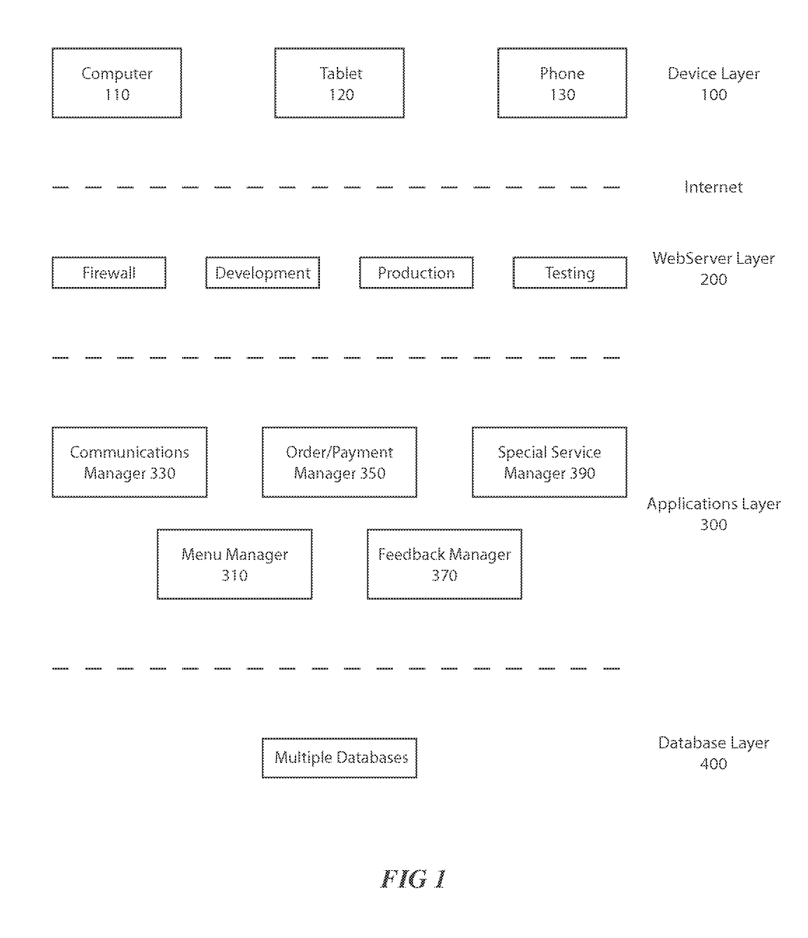

The need is addressed by a system for simultaneously linking restaurant diners and restaurant owners through an intelligent system that provides useful information to both. The overall system can be described in relation to FIG. 1, which begins with a device layer 100. In the device layer is shown a computer device 110, which might be a laptop or desktop computer system with access to the website via the Internet. Also shown in device layer 100 are either tablet 120 or smart phone devices 130 in the hands of potential or actual diners that have installed intelligent menu apps that can also access the website.

The device layer devices all communicate to the website through the Internet. All of the elements below the Internet line reside on the website servers.

The first layer 200 on the website (the WebServer Layer). The Webservers are the hardware servers that route the information coming in to the website to the right destinations. A Production server handles the day to day flow of information through the architecture. A Development server handles ongoing development work flowing into the website and a Test server directs test work to the correct destinations. These servers contain important applications (firewall, development, production, testing, etc.) that enable the protection of the overall system as well as continuous development, production, and testing of improved applications.

Below this WebServer Layer also and residing on the website servers is an Application Layer 300 containing a plurality of software applications that manage the initial signup of the restaurant owner into the intelligent menu system, that layout the menu information that can be accessed by diners (the Menu Manager) 310, that manage communications between the restaurant owner and the diners (the Communications Manager) 330, that manage orders and payments (the Order/Payment Manager) 350, that provide feedback from the diners to the restaurant owner (the Feedback Manager) 370, and that provide a variety of special services to both the diner and owner in supporting all of the activities of the intelligent menu (the Special Services Manager) 390. Each of these application layer manager application will be described further.

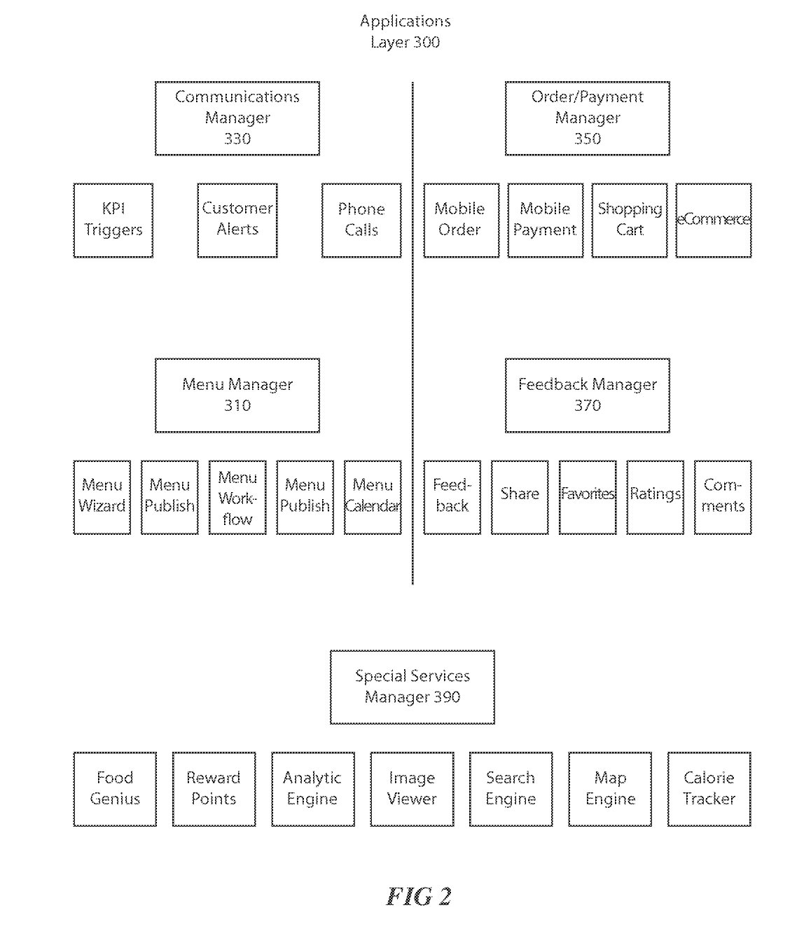

The devices shown on the device layer interact through a collection of software applications that reside at the application layer 300, which resides on website servers. Each of these applications provides information and capability to both the restaurant owners and diners as needed. Referring now to FIG. 2, the functions of each of the plurality of application packages will be described in turn. The restaurant owner, working through the computer (laptop, desktop) interface from device layer 100, logs onto the website for initial signup as an account in the intelligent menu system, and is led through a series of actions that include entering information into the system with respect to the restaurant, its location, profile, biography, photos, etc. A series of web pages then allow the entry of menu categories, menu items, menu photos, a calendar, etc., that enable the creation of a presentation to the diner of a compelling and searchable menu. These are handled by a plurality of software applications called the Menu Manager 310. The Menu Manager Suite comprises a menu wizard, a menu publisher, a menu workflow application, a menu preview application, and a menu calendar. This allows the restaurant to create a custom digital package that can be published at anytime.

A suite of application called the Feedback Manager 370 handles mobile communications from diners that can encompass direct feedback at any time during the dining experience but also includes the collection of diner ratings of menu items, servers, and other diner experience issues such as the cleanliness of the facilities. Diners can also register their favorites on menu items and make general comments for the restaurant owner. The Feedback Manager applications also allow sharing the diner experience through social media access.

Related to the input from the feedback Manager there is a Communications Manager 330 that constantly monitors the data collected from the Feedback Manager and enables the restaurant owner to respond instantly to any diner issues and resolve them. A Key Performance Indicator Trigger (KPI Trigger) application immediately notifies the restaurant owner when an key performance indicator (e.g. diner rating) exceeds a predetermined trigger point, allowing the restaurant owner to visit the table, or make an immediate call to the diner to resolve the issue if possible. As will be described later, each diner accumulates Reward Points as they frequent the restaurant and can be rewarded with more by the restaurant owner to address issues. These may be used to get discounted prices (or a free meal if warranted).

The Order/Payment Manager 350 suite of applications allows diners to easily place food orders from their seats and pay their bills before leaving. This manager also handles the billing of the restaurant owner for the Intelligent Menu service.

The Special Services Manager 390 comprises a special set of applications that supply special services to both the diners and the restaurant owners. A Food Genius is available on the mobile device app that acts as a helpful concierge and makes recommendations to diners about restaurants they would like, menu items they would like, etc. It acts a “genius” because it has collected over time all of the preferences of the particular diner and can make recommendations based on that information. The mobile device also has built in applications such as a search engine and map engine to aid potential diners to find their restaurant of choice and a calorie tracker to guide diners in menu choices.

For the restaurant owner the Special Services manager contains an analytic engine on the website to perform a wide variety of analysis of trends based on the large volume of diner feedback as to menu choices, ratings of various experiences, etc.

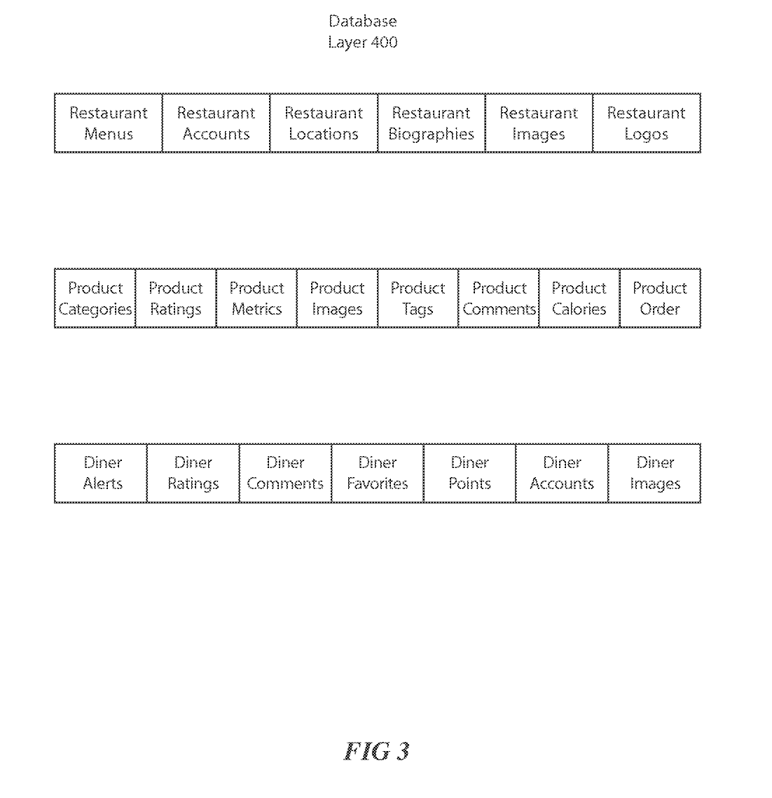

The large amount of data gathered by the intelligent menu must be carefully managed and this is done by a large plurality of databases on the Database Layer 400. Examples of the databases can be seen in FIG. 3. The examples shown are not exhaustive and additional databases can be added as the system grows. Theses databases could include compilations of restaurant locations, restaurants biographies, restaurant profiles, restaurant pictures, restaurant logos, restaurant menus, menu categories, restaurant product ratings, product metrics, product images, product tags, product comments, product calories, product orders, diner ratings, diner comments, diner favorites, diner points, diner accounts, diner pictures, and diner alerts. The applications layer applications are linked to many of these databases and the analytics engine for example can call on any of them to generate the reports of most use to the restaurant owner.

The website also contains an open API (application programming interface) that will allow third parties to integrate pieces of their websites into the Intelligent Menu.

In use the intelligent menu system provides an environment in which restaurant owners and diners can be in continuous communication and the diners can access information that can guide them to restaurants they prefer, enable them to review menu choices and order on their mobile device. The system provides many forms of feedback to the restaurant owner regarding the diner preferences. The diner can also pay for their meals, share information on their experience through social media, and receive reward points for their active participation. For the restaurant owner instant feedback of all kinds is made available so that the owner can quickly respond to problems and satisfy the diner before the diner leaves with a bad experience. In addition the restaurant owner has access to analytic capability to gather definitive data on the entire menu, the serving staff, and diners—information that was never available before.

Although certain embodiments and their advantages have been described herein in detail, it should be understood that various changes, substitutions and alterations could be made without departing from the coverage as defined by the appended claims. Moreover, the potential applications of the disclosed techniques is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized. Accordingly, the appended claims are intended to include within their scope such processes, machines, manufactures, means, methods or steps.

What is claimed is:

1. A system for simultaneously linking restaurant diners and restaurant owners through a website to provide useful information to both comprising:
an intelligent menu app for use by diners on a mobile smartphone device;
a website for use by restaurant owners on a computer interface within the plurality of restaurants and in communication via the website with the mobile smartphone devices of diners who enter their restaurant; and
at least one software application on the website for use by the restaurant owners in managing restaurant and menu information on each restaurant.

2. The system for simultaneously linking restaurant diners and restaurant owners through a website to provide useful information to both of claim 1 further comprising:
at least one software application on the website for managing orders and payments from the diners and the restaurant owners;
at least one software application on the website for managing feedback from diners to the restaurant owners on the dining experience;
at least one software application on the website for managing direct communications between the diners and the restaurant owner.

3. The system for simultaneously linking restaurant diners and restaurant owners through a website to provide useful information to both of claim 2 further comprising:
at least one software application on the website for providing special services for the diners and the restaurant owners.

4. The system for simultaneously linking restaurant diners and restaurant owners through a website to provide useful information to both of claim 2 further comprising a plurality of databases maintaining information on restaurants, restaurant products, and diner information.

5. The system for simultaneously linking restaurant diners and restaurant owners through a website to provide useful information to both of claim 4 further comprising:
at least one database on the website for storing and retrieving information on a plurality of restaurants;
at least one database on the website for storing and retrieving information on restaurant menus, and menu categories;
at least one database on the website for storing and retrieving information on restaurant products; and
at least one database on the website for storing and retrieving information on diners.

6. The system for simultaneously linking restaurant diners and restaurant owners through a website to provide useful information to both of claim 4 further comprising:
at least one analytics application on the website for analyzing the information on said databases to provide seeking diners with restaurant recommendations; and
at least on analytics application on the website for analyzing the information on said databases to provide restaurant owners intelligent information on the menu and server preferences of their diners.

7. The system for simultaneously linking restaurant diners and restaurant owners through a website to provide useful information to both of claim 2 further comprising:
at least one analytics application on the website for analyzing the information on said databases to provide seeking diners with restaurant recommendations; and
at least on analytics application on the website for analyzing the information on said databases to provide restaurant owners intelligent information on the menu and server preferences of their diners.

8. The system for simultaneously linking restaurant diners and restaurant owners through a website to provide useful information to both of claim 1 wherein:
the intelligent menu app for use by diners on a mobile smartphone device can search the menu and order a meal by communicating directly with a website menu application;
the diner using the intelligent menu app device can provide menu ratings, server ratings, and general service ratings to the restaurant during and after the dining experience; and
the diner using the intelligent menu app device can pay for their meal directly from the intelligent menu app.

9. The system for simultaneously linking restaurant diners and restaurant owners through a website to provide useful information to both of claim 1 further comprising an Open API Interface (SDK) that will allow other companies to develop plug-in-play applications that can plug into the intelligent menu application and access the data and analytics.

10. A method for simultaneously linking restaurant diners and restaurant owners through a website to provide useful information to both comprising:
providing a first intelligent menu app for use by diners on a mobile smartphone device;
providing a website for use by restaurant owners on a computer interface within the plurality of restaurants and in communication via the website with the mobile smartphone devices of diners who enter their restaurant; and
providing information and capability to the restaurant owners in managing restaurant and menu information on each restaurant.

11. The method for simultaneously linking restaurant diners and restaurant owners through a website to provide useful information to both of claim 10 further comprising:
providing information and capability on the website for managing orders and payments from the diners and the restaurant owners;
providing information and capability on the website for managing feedback from diners to the restaurant owners on the dining experience; and
providing information and capability on the website for managing direct communications between the diners and the restaurant owner.

12. The method for simultaneously linking restaurant diners and restaurant owners through a website to provide useful information to both of claim 11 further comprising providing information and capability on the website for providing special services for the diners and the restaurant owners.

13. The method for simultaneously linking restaurant diners and restaurant owners through a website to provide useful information to both of claim 10 further comprising a plurality of databases maintaining information on restaurants, restaurant products, and diner information.

14. The method for simultaneously linking restaurant diners and restaurant owners through a website to provide useful information to both of claim 11 further comprising:
providing from a database on the website information on a plurality of restaurants;
providing from a database on the website information on a plurality of restaurant menus, and a plurality of menu categories;
providing from a database on the website information on a plurality of restaurant products; and
providing from a database on the website information on a plurality of diner metrics.

15. The method for simultaneously linking restaurant diners and restaurant owners through a website to provide useful information to both of claim 13 further comprising:
providing via at least one analytics application to analyze the information on said databases to provide seeking diners with restaurant recommendations; and
providing via at least one analytics application to analyze the information on said databases to provide restaurant owners intelligent information on the menu and server preferences of their diners.

16. The method for simultaneously linking restaurant diners and restaurant owners through a website to provide useful information to both of claim 8 wherein the diner can use the intelligent menu app to:
search the menu and order a meal by communicating directly with a website menu application;
provide menu ratings, server ratings, and general service ratings to the restaurant during and after the dining experience; and
pay for their meal directly from the intelligent menu app.
